(19) United States
(12) Patent Application Publication
(10) Pub. No.: US 2002/0046232 A1
(43) Pub. Date: Apr. 18, 2002

(54) Organizing content on a distributed file-sharing network

(76) Inventors: Colin John Adams, Sydney (AU); Paul Scott McNally, Sydney (AU)

Correspondence Address: CHRISTIE, PARKER & HALE, LLP, 350 WEST COLORADO BOULEVARD, SUITE 500, PASADENA, CA, 91105, US

(21) Appl. No.: 09/954,620

(22) Filed: Sep. 17, 2001

(30) Foreign Application Priority Data
Sep. 15, 2000 (AU) AU PRO157/00

(51) Int. Cl. G06F 15/16

(52) U.S. Cl. 709/200

(57) ABSTRACT

A system for and method of locating desired files in distributed file sharing over a computer network is disclosed, whereby each file 6 is categorized according to the content of the file 6 and information about files 6 resides on at least one central index server 3. Client terminals 1 publish files 6 for other client terminals 1 in the computer network 2. The central index servers 3 store the list of files 6 in the system. Client terminals 1 query the central index servers 3 to determine the set of files 6 currently available in the system. A central index server 3 returns a list of files 6 and file locations which match the query results and are currently available. The client terminal 1 issuing the search can retrieve the file 6 from the search results by requesting it from one of the client terminals 1 specified in the search results.

### TECHNICAL FIELD

The present invention relates to a new type of system for and method of distributed file sharing over a computer network, and in particular, to a system for and method of distributed file sharing over a computer network, whereby each file is categorized according to the content of the file and information about files resides on at least one central index computer.

### BACKGROUND ART

In a networked data communications system, users have access to terminals which are capable of requesting and receiving information from local or remote information sources. In such a system a terminal may be any type of computer or computerised device, a personal computer (PC), a mobile or cellular phone, a mobile data terminal, a portable computer, a personal digital assistant (PDA), a pager, or any other similar type of electronic device. The capability of the terminal to request and/or receive information can be provided by an application program, hardware or other such entity. A terminal may be provided with associated devices, for example an information storage device such as a hard disk drive.

In such a system an information source may be a server or any other type of computer or terminal (for example, a PC computer) coupled to an information storage device (for example, a hard disk drive). The exchange of information (i.e., the request and/or receipt of information) between the terminal and the information source, or two or more terminals, is facilitated by a connection referred to as a communication channel. The communication channel can be physically realised via a metallic cable (for example, a telephone line), semiconducting cable, an electromagnetic signal (for example, a radio frequency (RF) signal), an optical fibre cable, a microwave link, a satellite link or any other such medium or combination thereof connected to a network infrastructure.

The network infrastructure may be a telephone switch, a base station, a bridge, a router, or any other such specialised component, which facilitates the connection between a terminal and the network. Collectively, the interconnected group of terminals, physical connections, infrastructure and information sources is referred to as a computer network or data communications network.

The computer network itself may take a variety of forms. It may be located within a local geographic area, such as an office building, and consist of only a limited number of terminals and information sources. This type of computer network is commonly referred to as a Local Area Network (LAN). On a broader scale, it may be larger and support more users over a wider geographic area, such as across a city. This type of network is commonly referred to as a Wide Area Network (WAN). On an even broader scale LAN and WAN networks may be interconnected across a country or globally. An example of a globally connected computer network is the Internet.

To a user the Internet appears to be a single unified computer network, although in reality it consists of many different types of computer platforms utilising many diverse data communications technologies. The technologies are connected together in such a manner so they appear transparent to the user. This transparency is made possible through the use of a standard communications protocol suite known as Transmission Control Protocol/Internet Protocol (TCP/IP).

Files are stored in various information storage devices associated with at least one terminal, thereby comprising an information source. A user can access files from an information source, if authorised, by connecting to a computer network and requesting the files for viewing or downloading.

Presently, it is known to access files from a terminal whereby the files are hosted on an information source. Various types of files, for example audio files, video files, text files, etc., can be downloaded to a local information storage device, or simply accessed, for example as streaming data, at an information source.

A limitation with presently known systems and methods of file sharing or exchange is that it is difficult to locate files of interest to a user. That is, locating desired files on a distributed file-sharing network is presently problematic.

A user may presently utilise a search engine to attempt to locate Internet websites of interest on the basis of key-word associations. However, the material produced is often irrelevant and not necessarily the type of file, for example audio, for which the user was looking.

Furthermore, a user is often required to perform further searches within a possibly relevant web-site to attempt to locate the type of file for which they are searching, for example an audio file as opposed to an image file.

As an example, a user may desire an image of a particular person. Presently, by searching the Internet for the person's name, only text, or irrelevant web-sites making fleeting textual reference to the person might be located. However, an image of the person may exist at some location under an arbitrary file name, for example, 123abc.jpg. Without any other information associated with this jpeg image file, the jpeg image file of the particular person would not be identified as relevant to the user's search request and would not be found.

Still furthermore, the Applicant's are presently not aware of any system or method which can selectively facilitate the locating of any specific type of file, for example audio, video, image, text, executable, etc, which is relevant to a user's request.

This identifies a need for a new type of system for and method of distributed file sharing over a computer network which overcomes or at least ameliorates the problems inherent in the prior art.

### DISCLOSURE OF INVENTION

In a preferred form of the present invention, the present invention provides a system for allowing a user to search for and locate a file in a distributed file sharing computer network, the system including: a first client terminal, and at least one further client terminal; at least one central index server; the computer network providing a communication channel between the first client terminal and the at least one further client terminal, and the computer network providing a communication channel between the first client terminal and the at least one central index server; files which are stored in any of the client terminals, the files having been categorised into file categories according to the content or type of the file; each central index server storing, for each file, information on the file including the file name, the file type, the category or categories in which the file is located, and, the location of the file in the computer network; a search results list which is transmitted to the first client terminal in response to the user's search request, the search results list generated by the at least one central index server searching file category information and file type information; the search results list containing a link to at least one file which is located on the further client terminal, if any files are identified in the search.

Also preferably, the search results list is generated by the central index server searching file category information and file type information, but not actual file names. The file may be any of the following types: audio, video, image, text, ascii, executable, data, or compressed. Also, the file category may be a folder or directory on a client terminal. A further client terminal can be an information source. In another form of the invention, changes to file categories or the contents of file categories are automatically updated on the central index servers. Additionally, a file can be stored in more than one file category, and on more than one client terminal. It should be noted that the search results list can be considered to be generated by the user manually browsing the central index server file categories from the first client terminal.

In yet a further preferred form of the present invention, there is provided a method for allowing a user to search for and locate a file in a distributed file sharing computer network, wherein there is provided: a first client terminal, at least one further client terminal, and at least one central index server; the computer network providing a communication channel between the first client terminal and the at least one further client terminal, and the computer network providing a communication channel between the first client terminal and the at least one central index server; files which are stored in any of the client terminals, the files having been categorised into file categories according to the content or type of the file; each central index server storing, for each file, information on the file including the file name, the file type, the category or categories in which the file is located, and, the location of the file in the computer network; the method comprising the steps of:

the user entering a search request for a file into the first client terminal;

the first client terminal transferring the search request to the central index server, the central index server searching the file categories and file types located on the central index server for a file which matches the user request;

the central index server providing the file name, the file type, the category or categories in which the file is located, and the location of the file to the first client terminal for any located files;

the user selecting a file from the search results list;

the first client terminal being placed in communication with the further client terminal in which the selected file resides;

the selected file then being accessed by or downloaded to the first client terminal from the further client terminal.

In other embodiments of the invention computer authorisation or a password can be required to access the selected file or the further computer terminal, and a client terminal need not be permanently connected to the computer network.

In still a further preferred form of the present invention, there is provided a method for organizing files, and allowing a user to search for and locate a file, in a distributed file sharing computer network, includes the steps of: a first user saving a file into a file category, the file stored on a first client terminal; automatically updating the change to the file category on file category information stored on a central index server and storing the location of the file on the central index server; a second user accessing a second client terminal, the second client terminal being remote to the first client terminal, and browsing file categories by the second client terminal querying the central index server; the second user locating a file category of interest and selecting a file from the available list of files in the file category; the location of the selected file being transmitted from the central index server to the second client terminal; the second client terminal making a peer-to-peer network connection to the first client terminal to obtain the selected file; and subsequent to the file being downloaded to the second client terminal, the file category information on the central index server is updated to indicate that the second client terminal is also a source for the selected file.

In one particular embodiment a file category is a directory on a hard-drive. Furthermore, the file categories may be hierarchical in structure. In a further embodiment security access validation may be required prior to a user being permitted to make changes to, or access, certain file categories.

In yet another form of the invention there is provided a system for and method of distributed file sharing over a computer network, substantially according to the embodiment described in the specification with reference to the accompanying figures. Accordingly, the present invention seeks to provide these and other features providing a system for and method of distributed file sharing over a computer network.

### BRIEF DESCRIPTION OF FIGURES

The present invention will become apparent from the following description, which is given by way of example only, of a preferred but non-limiting embodiment thereof, described in connection with the accompanying figures, wherein:

FIG. 1 illustrates a particular embodiment of the present invention wherein, the figure shows the broad structure of the computer network.

FIG. 2 illustrates a particular embodiment of the present invention wherein, the figure shows an example of the relationship of files to file categories on a client terminal.

### MODES FOR CARRYING OUT THE INVENTION

The present invention provides a system for and method of distributed file sharing over a computer network. For the purposes of the present invention, a client terminal is any type of terminal hereinbefore mentioned. Furthermore, a client terminal may be an information source itself. A central index server is typically an information source.

The following modes are described as applied to the written description and appended claims in order to provide a more precise understanding of the subject matter of the present invention.

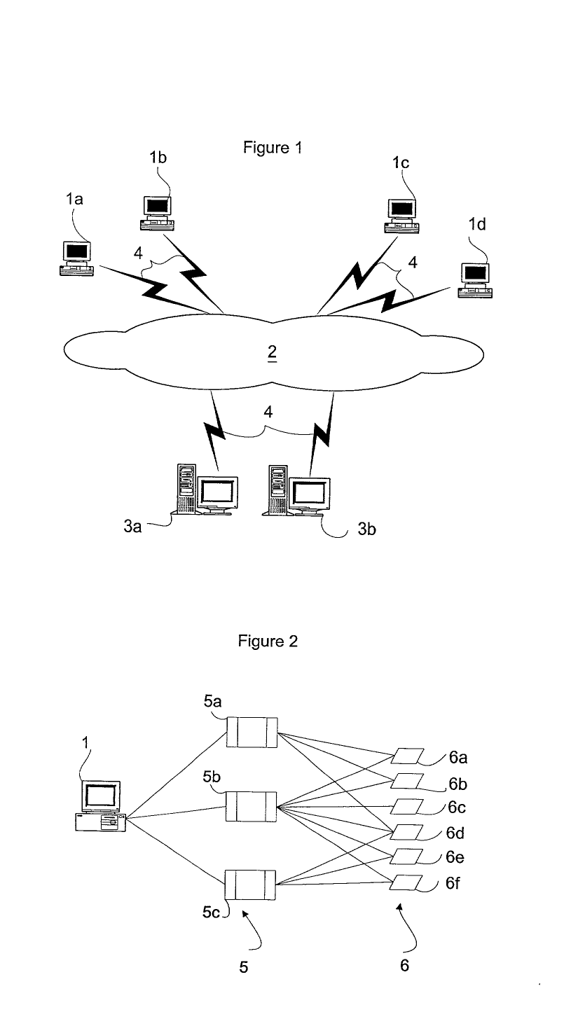

A preferred, but non-limiting, embodiment of the present invention is shown in the figures. In FIG. 1, client terminals 1 are illustrated as being connected to the Internet 2. The central index servers 3 are also connected to the Internet 2. There is a communication channel 4, via the Internet, between two or more client terminals. Obviously, the present invention is not limited to the number of computers or terminals illustrated in the figure. Furthermore, it is not a specific requirement that the Internet 2 is used as the computer network.

In FIG. 2 an example of the relationship which may exist between a given client terminal 1, file categories 5 and files 6 are illustrated. It should be noted that the figure is provided by way of example only and that the particular categorisation, or number of file categories or files shown, is not limiting. Each client terminal 1 having memory means allocates a component of memory to a file category 5. For example, a file category 5a may be associated with a specific folder in a computer hard drive. A file category 5 contains files 6 which are related according to the subject matter of the file category 5. Any number of file categories 5 and files 6 can be provided. For example, file category 5a may contain files 6a, 6b and 6d, and file category 5b may contain files 6a to 6f, as illustrated.

A file 6 need not be stored only in a single category 5, a file 6 can reside in multiple categories 5 on a client terminal 1, and can be indexed under several categories 5 by a central index server 3. Even if a file 6 does initially reside in only a single category 5 on a client terminal 1, a central index server 3 may index the file 6 under more than one category 5.

Client terminals 1 publish files 6 for other client terminals 1 in the computer network 2. The central index servers 3 store the list of files 6 in the system, including the subset of files currently available. Client terminals 1 can query the central index servers 3 to determine the set of files 6 currently available in the system. Files 6 include, but are not limited to, text documents, images, movies, audio files, spreadsheets and other types of documents.

Client terminals 1 search for files 6 by querying the central index servers 3. A central index server 3 returns a list of files 6 and file locations which match the query results and are currently available. The client terminal 1 issuing the search can retrieve a file 6 from the search results by requesting it from one of the client terminals 1 specified in the search results (a peer-to-peer transfer).

It should be noted that use of the term ‘search’ in this specification should be taken to apply both to automatic searches performed by computer software and to manual searching or browsing of categories and files by a user.

For example, a user may be searching for an image file of a particular person. The name of the image file may have an arbitrary name with no textual reference to the name of the person. The image file would be categorized in an appropriate file category which would have some relationship to the name of the person. Assume the user is using client terminal 1a to search for an image file, which unbeknown to the user files 6a, 6b or 6d would suffice, by querying the central index server 3a or 3b. The central index server 3a returns a list of files 6a, 6b or 6d and file locations contained in file category 5a which match the query results and are currently available on client terminal 1c. The client terminal 1a issuing the search can retrieve a file, for example file 6a, from the search results by requesting it from the client terminal 1c, or other terminal if more than one client terminal is specified in the search results (a peer-to-peer transfer).

Each file 6 in the computer network 2 is stored in one or more categories 5. Central index servers 3 control the list of categories in the system.

The contents of the files 6 are stored on client terminals 1. Each file 6 is stored in a directory on the client terminal 1 which is associated with one of the central file categories 5. Each client terminal 1 may have a different set of files 6 published.

Files 6 can belong to public or private categories 5. Only authorized users can view or publish files in private categories. Files in private categories are not reclassified or removed except by authorized users.

The set of categories 5 that each file 6 is stored in is stored on the central index servers 3. A unique signature of the file 6 is used to determine whether two files, eg. 6a and 6e, are the same. Changes to the file category list are made manually on the central index servers 3 (computers). File category list changes are propagated to all users.

Users publish files by placing them into a directory that is associated with a file category 5. If the file 6 has not been published before, the first file category it will be associated with is the file category it was placed in by the user who first published the file 6.

Users with sufficient access rights may also manually modify the categories that a file is associated with.

The following example provides a more detailed outline of one embodiment of the present invention. This example is intended to be merely illustrative and not limiting of the scope of the present invention.

Example Usage:

1. User A in Sydney saves a new Word document called “Marketing Report.doc” into a special folder using software embodying the invention. The file is stored in a directory on the local hard disk drive. The directory is associated with a category called “FileCat.Marketing Documents” in the hierarchy maintained by the central index servers. The client software is responsible for maintaining a database of directories associated with categories on the central index servers and the list of files in each directory.

2. The client software automatically detects the new file. A checksum of the file is generated and, after security access is validated using a role based security mechanism, the information is sent to the central index servers where the new file is added to the central index. The central index servers also note that the file is available on User A's PC.

3. User B in New York uses the invention to browse the hierarchical category tree, similar to browsing a local hard disk drive. User B only sees the categories in the tree they have permission to access. They browse into the category “FileCat.Marketing Documents” and view the files currently available in this category. The file list is obtained by the client software by querying the central index servers.

4. User B selects the file called “Marketing Report.doc” from the list of currently available files and instructs the software to download the file. The software on the central index servers obtains a list of locations for the file based on the unique signature of the file and returns this list to the client software on User B's computer. The software on User B's computer then makes a peer-to-peer network connection to User A's computer to obtain the file. Peer-to-peer connections are made either via a direct TCP/IP connection, or via a relay server that passes information between nodes on the network.

5. Once the file is downloaded to User B's computer, the software automatically adds User B's computer as a possible source for the file “Marketing Report.doc” on the central index servers.

It should be noted that the computer network as referenced in this specification should be taken to include all forms of connected or communicating computers or terminals having at least two terminals connected or communicating as hereinbefore described. That is, the term computer network should be taken to include any type of terminal as hereinbefore defined, computer, computerised device, peripheral computer equipment, computerised accessory, mobile or cellular phone, digital electronic device or other similar type of computerised electronic device or part thereof which is rendered such that it is capable of communicating with at least one of any of the aforementioned entities. Said communication of information or data can occur over any data communications network, computer network, wireless network, internetwork, intranetwork, local area network (LAN), wide area network (WAN), the Internet and developments thereof, transient or temporary network, combinations of the above or any other type of network providing for computerised, electronic or digital devices. Furthermore, references to the terms connecting, communicating, transmitting, requesting, receiving, exchanging and the like, and permutations thereof, as applied to the term computer network and/or components thereof should be taken to pertain to the transfer of information or data.

Such transfers of information or data can be facilitated for by any form of entity/entities for facilitating such, including, but not limited to, metallic wires or cables, semi-conducting wires or cables, optical fibres and optical devices, wireless means, electromagnetic waves and the like and modulations thereof, acoustic waves and the like and modulations thereof, control of electric and/or magnetic fields, and/or the transportation of all forms of memory devices.

Thus, there has been provided in accordance with the present invention, a system for and method of distributed file sharing over a computer network which satisfies the advantages set forth above.

The invention may also be said broadly to consist in the parts, elements and features referred to or indicated in the specification of the application, individually or collectively, in any or all combinations of two or more of said parts, elements or features, and where specific integers are mentioned herein which have known equivalents in the art to which the invention relates, such known equivalents are deemed to be incorporated herein as if individually set forth.

Although the preferred embodiment has been described in detail, it should be understood that various changes, substitutions, and alterations can be made herein by one of ordinary skill in the art without departing from the spirit or scope of the present invention.

1. A system for allowing a user to search for and locate a file in a distributed file sharing computer network, the system including:
a first client terminal, and at least one further client terminal;
at least one central index server;
the computer network providing a communication channel between the first client terminal and the at least one further client terminal, and the computer network providing a communication channel between the first client terminal and the at least one central index server;
files which are stored in any of the client terminals, the files having been categorised into file categories according to the content or type of the file;
each central index server storing, for each file, information on the file including the file name, the file type, the category or categories in which the file is located, and, the location of the file in the computer network;
a search results list which is transmitted to the first client terminal in response to the user's search request, the search results list generated by the at least one central index server searching file category information and file type information;
the search results list containing a link to at least one file which is located on the further client terminal, if any files are identified in the search.

2. The system as claimed in claim 1, wherein the search results list is generated by the central index server searching file category information and file type information, but not actual file names.

3. The system as claimed in claim 1, wherein the search results list is generated by the user manually browsing the central index server file categories from the first client terminal.

4. The system as claimed in claim 1, wherein the file is any of the following types: audio, video, image, text, ascii, executable, data, or compressed.

5. The system as claimed in claim 1, wherein the file category is a folder or directory on a client terminal.

6. The system as claimed in claim 1, wherein a further client terminal is an information source.

7. The system as claimed in claim 1, wherein changes to file categories or the contents of file categories are automatically updated on the central index servers.

8. The system as claimed in claim 1, wherein a file can be stored in more than one file category, and on more than one client terminal.

9. A method for allowing a user to search for and locate a file in a distributed file sharing computer network, wherein there is provided: a first client terminal, at least one further client terminal, and at least one central index server; the computer network providing a communication channel between the first client terminal and the at least one further client terminal, and the computer network providing a communication channel between the first client terminal and the at least one central index server; files which are stored in any of the client terminals, the files having been categorised into file categories according to the content or type of the file; each central index server storing, for each file, information on the file including the file name, the file type, the category or categories in which the file is located, and, the location of the file in the computer network; the method comprising the steps of:
the user entering a search request for a file into the first client terminal;
the first client terminal transferring the search request to the central index server, the central index server searching the file categories and file types located on the central index server for a file which matches the user request;
the central index server providing the file name, the file type, the category or categories in which the file is located, and the location of the file to the first client terminal for any located files;
the user selecting a file from the search results list;
the first client terminal being placed in communication with the further client terminal in which the selected file resides;
the selected file then being accessed by or downloaded to the first client terminal from the further client terminal.

10. The method as claimed in claim 9, wherein the search results list is generated by the user manually browsing the central index server file categories from the first client terminal.

11. The method as claimed in claim 9 wherein, computer authorisation or a password can be required to access the selected file or the further computer terminal.

12. The method as claimed in claim 9, wherein a client terminal need not be permanently connected to the computer network.

13. The method as claimed in claim 9, wherein if a user makes changes to a file on a client terminal, including: to the name of a file; to the location of a file; or, to a file category, the information is automatically updated in the central index servers.

14. A method for organizing files, and allowing a user to search for and locate a file, in a distributed file sharing computer network, includes the steps of:
a first user saving a file into a file category, the file stored on a first client terminal;
automatically updating the change to the file category on file category information stored on a central index server and storing the location of the file on the central index server;
a second user accessing a second client terminal, the second client terminal being remote to the first client terminal, and browsing file categories by the second client terminal querying the central index server;
the second user locating a file category of interest and selecting a file from the available list of files in the file category;
the location of the selected file being transmitted from the central index server to the second client terminal;
the second client terminal making a peer-to-peer network connection to the first client terminal to obtain the selected file; and
subsequent to the file being downloaded to the second client terminal, the file category information on the central index server is updated to indicate that the second client terminal is also a source for the selected file.

15. The method as claimed in claim 14, wherein a file category is a directory on a hard-drive.

16. The method as claimed in claim 14, wherein the file categories are hierarchical in structure.

17. The method as claimed claim 14, wherein security access validation is required prior to a user being permitted to make changes to, or access, certain file categories.
